(19) United States
(12) Patent Application Publication
(10) Pub. No.: US 2004/0146770 A1
(43) Pub. Date: Jul. 29, 2004

(54) Fuel cell control valve

(76) Inventor: Michael Colton, Beverly Hills, MI (US)

Correspondence Address: WILLIAM M HANLON, JR, YOUNG & BASILE, PC, 3001 WEST BIG BEAVER ROAD, SUITE 624, TROY, MI, 48084-3107, US

(21) Appl. No.: 10/739,235

(22) Filed: Dec. 18, 2003

Related U.S. Application Data
(60) Provisional application No. 60/434,605, filed on Dec. 18, 2002.
(60) Provisional application No. 60/434,842, filed on Dec. 19, 2002.

(51) Int. Cl. H01M 8/04

(52) U.S. Cl. 429/34; 429/38

(57) ABSTRACT

A control valve is provided for regulating flow and controlling pressure through a fuel cell stack having a plurality of fuel cells arranged in a layer configuration. A control valve is positioned at at least one of the four corners of the stacked configuration. The control valve includes a body and a tubular cylinder selectively rotatable within the body. A plurality of ports are vertically spaced in the body and in the tubular cylinder and in communication with the flow channels defined by each layer of the fuel cell.

This application claims priority of provisional patent applications S. N. 60/434,605, filed on Dec. 18, 2002 and S. No. 60/434,842 filed on Dec. 19, 2002.

### BACKGROUND OF THE INVENTION

This invention relates to regulating a flow through a fuel cell.

A fuel cell is an electrochemical device that converts chemical energy produced by a reaction directly into electrical energy. For example, one type of fuel cell includes a proton exchange membrane (PEM), a membrane that may permit only protons to pass between an anode and a cathode of the fuel cell. At the anode, diatomic hydrogen (a fuel) is oxidized to produce hydrogen protons that pass through the PEM. The electrons produced by this oxidazation travel through circuitry that is external to the fuel cell to form an electrical current. At the cathode, oxygen is reduced and reacts with the hydrogen protons to form water.

Because a single fuel cell typically produces a relatively small voltage (around 1 volt) several serially connected fuel cells may be formed in an arrangement called a fuel cell stack to produce a higher voltage. The fuel cell stack may include different plates that are stacked one on top of the other in the appropriate order and each plate may be associated with more than one fuel cell of the stack. The plates may be made from a metal or electrically conductive composition material and include various channels and orifices to, as examples, route the above-described reactants and products through the fuel cell stack. Several PEMs (each associated with a particular fuel cell) may be dispersed throughout the stack between the anodes and cathodes of the different fuel cells and coolant layers may be provided between each pair of anode and cathode layers. The anode and the cathode may each be made out of an electrically conductive gas diffusion material such as a carbon cloth or paper material. An individual fuel cell includes a first passage for moving a fuel stream, usually hydrogen, and a second passage for moving a stream of an oxidized agent, usually air or oxygen. The first and second passages are separated by the PEM membrane and the reaction between the streams takes place across the PEM membrane. The typical fuel cell includes numerous pairs of first and second passages arranged in a stack.

### SUMMARY OF THE INVENTION

The present invention provides a valve for selectively controlling the movement of the fuel stream and/or the stream of oxidized agent through the passages.

In one aspect of the invention, a valving system is provided for use with a fuel cell stack having successive alternating layers of air and hydrogen passageways wherein the valving system includes a tubular cylinder having a plurality of vertically spaced and angularly staggered aperture means; a means for mounting the tubular cylinder for rotation about its lengthwise axis and means for bringing the plurality of vertically spaced; and angularly staggered aperture means into communication with the successive alternating layers of air in the hydrogen passageways as tubular cylinder is rotated.

In another aspect of the invention, the valving system further includes a housing extending the full height of the fuel cell stack wherein the housing has a central bore for receiving the tubular cylinder and the housing has a face with a plurality of apertures in communication with at least some of the successive alternating layers of the air in hydrogen passageways.

In another aspect of the invention, the housing and tubular cylinders are positioned at an anode output of the fuel cell stack.

In yet another aspect of the invention, the plurality of apertures in the face of the housing includes a set of apertures for each anode layer in the fuel cell stack.

In another aspect of the invention, the set of apertures are angularly staggered with respect to each other in a helix fashion.

And further, in another aspect of the invention, the valving system includes an electric motor with an output shaft drivingly connected to a lower end of the tubular cylinder for selective rotation of the tubular cylinder.

### BRIEF DESCRIPTION OF THE DRAWINGS

The description herein makes reference to the accompanying drawings wherein like reference numerals refer to like parts throughout the several views, and wherein:

FIG. 1 is a schematic perspective view of a fuel cell according to the invention;

FIG. 2 is a schematic view of the fuel cell taken on line 2-2 of FIG. 1;

FIG. 3 is a cross-sectional view taken on line 3-3 of FIG. 1;

FIG. 4 is a schematic version of the cross-sectional view of FIG. 3;

FIG. 5 is a perspective view of a control valve according to the invention;

FIG. 6 is an exploded view of the valve in FIG. 5 illustrating certain details;

FIG. 7 is a developed view of the surface of one of the components of the invention control valve as configured in FIG. 6;

FIG. 8 is a cross-sectional view taken on line 8-8 of FIG. 5;

FIG. 8a illustrates a modification of the structure seen in FIG. 8;

FIG. 9 is a perspective view of an alternate embodiment of one of the valve components; and

FIG. 10 is a developed view of the surface of one of the valve components in a further alternate embodiment of the invention.

### DESCRIPTION OF THE PREFERRED EMBODIMENT

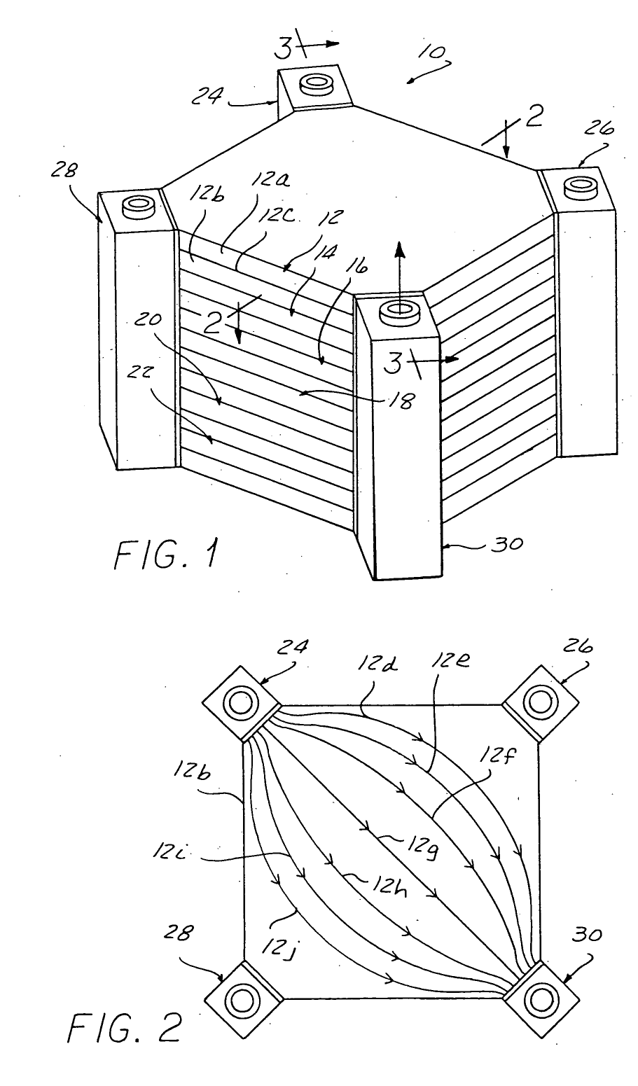

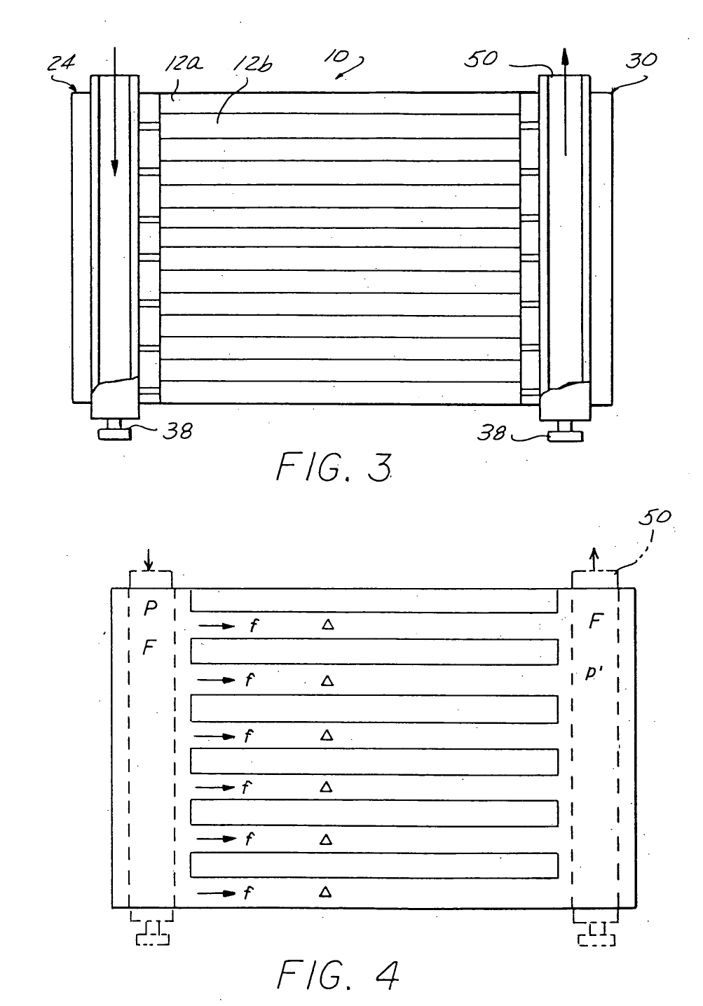

FIG. 1 schematically illustrates a fuel cell stack 10 including a plurality of fuel cells 12, 14, 16, 18, 20 and 22 arranged in a stacked configuration with a valve 24, 26, 28 and 30 according to the invention positioned respectively at the four corners of the stacked configuration. For illustrative purposes, valve 24 is positioned at the anode input, valve 30 is positioned at the anode output, valve 28 is positioned at the cathode input, and valve 26 is positioned at the cathode output.

In overview, the invention valve 24, 26, 28, 30 can be used as a back pressure or flow control method for gas management in a fuel cell stack 10. When used integral to the stack 10 as shown, it provides a means of controlling pressure and flow of gases in each individual cell rather than using an external valve to control the whole stack pressure and flow.

As shown, a valve 24, 26, 28, 30 according to the invention is utilized at both the input and output ends of both the anode (fuel) and cathode (air) sides of the stack 10. It will be understood that the invention valve 24, 26, 28, 30 can be utilized as shown on all four corners of the stack to control both the input and the output of both the anode and cathode; can be used only at the output of the anode; can be used at both the input and the output of the anode; or can be used at the input and output of the anode and the input and/or output of the cathode.

In overview, each cell includes a first layer or path for conducting hydrogen from the anode input to the anode output, a second layer or path for conducting air from the cathode input to the cathode output, and a PEM interposed between the two layers. For example, cell 12 may include an upper cathode layer 12a, a lower anode layer 12b and a PEM 12c interposed between the layers, all in known fashion. It will further be understood that, in known fashion, a plurality of channels extend through each layer between the respective input and output whereby to define a flow of gases through each layer between the input and output. For example, as seen in FIG. 2 with respect to anode layer 12b, a plurality of channels 12d-12j may extend through layer 12b to interconnect the anode input and the anode output.

The invention control valve 24, 26, 28, 30 will now be described with respect to the control valve 30 positioned at the anode output. It will be understood that the other control valves 24, 26, and 28, if utilized, have a similar construction.

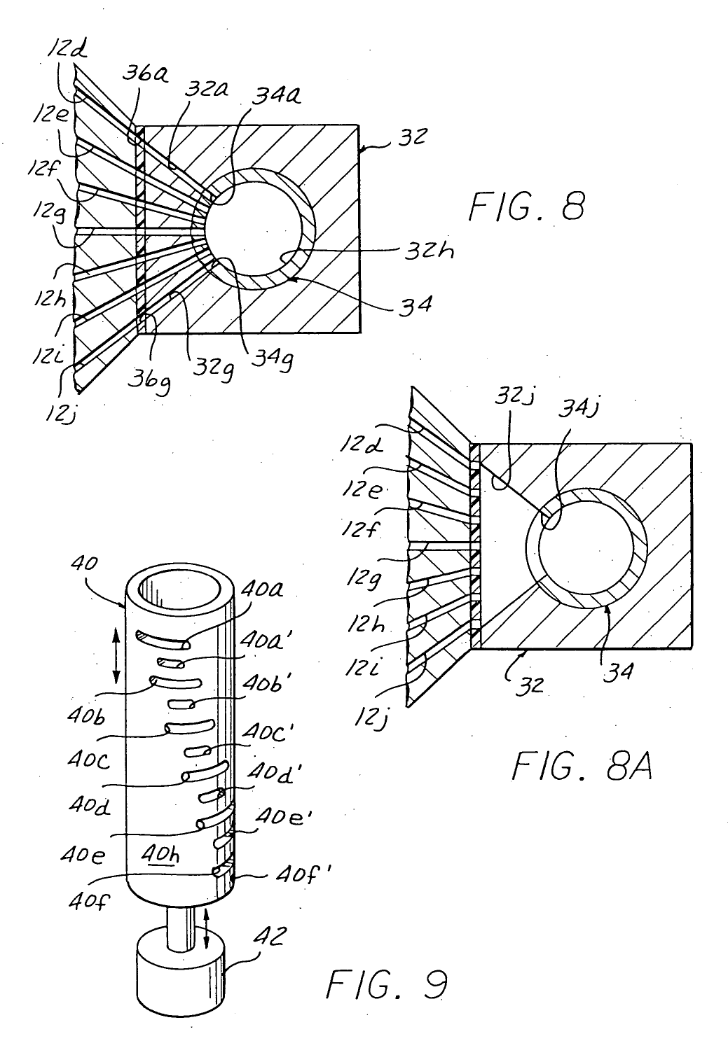

As seen in FIG. 6, control valve 30 includes a body 32 and a tubular cylinder 34. The body 32 is elongated, extends the full height of the fuel cell stack, has a generally rectangular cross-sectional configuration, and defines a central vertical axial bore 32h sized to receive tubular cylinder 34. A silicon seal 36 is positioned against one face of the body. A plurality of apertures or ports are provide in vertically spaced rows in the seal 36 and in body 32 for respective communication with the flow channels defined at each anode layer of the fuel cell. For example, with reference to anode layer 12b, a plurality of ports 36a-36g may be provided in a row in seal 36 for communication with a plurality of angled passages 32a-32g (FIG. 8) in body 32. Each passage 32a-32g will be seen to communicate at an outboard end with a respective port 36a-36g and will be seen to open at an inboard end in the interior of tubular cylinder 34 so that the flow channels 12d-12j coact with the ports 34a-34g and the passages 36a-36g to define a hydrogen flow path extending from the flow channels 12d-12j to the interior of bore 32h.

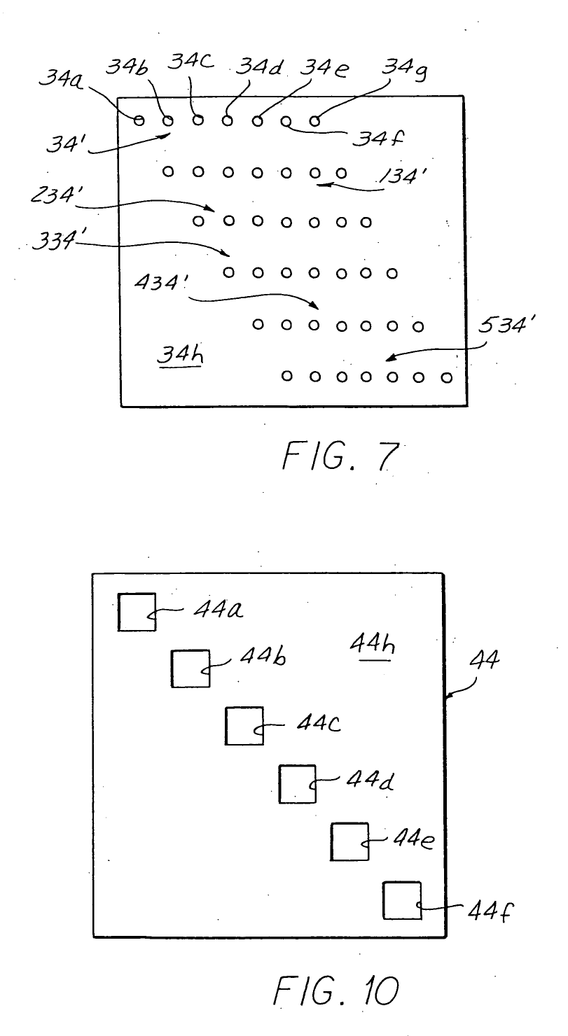

Tubular cylinder 34 defines an annular wall 34h in which are formed a series of sets of apertures or ports for respective communication with the individual anode layers of the fuel cell via passages in the body and apertures in the silicon seal. For example, annular wall 34h may be provide with a first set of ports 34a-34g spaced circumferentially about an arc of the outer periphery of the annular wall in angular spacing corresponding to the angular spacing of the passages 32a-32g in the housing 32 so that, upon rotation of the tubular cylinder 34, ports 34a-34g may be brought into respective alignment with the passageway 32a-32g. It will be understood that a similar set of ports or apertures is provided for coaction with each anode layer 12, 14, 16, 18, 20, 22 in the fuel cell stack 10 and it will be seen that the respective sets of ports are angularly staggered with respect to each other and specifically are arranged in a helix fashion with respect to the exterior periphery 34h of the tubular cylinder 34. The relative helical arrangement of the sets of apertures 34′, 134′, 234′, 334′, 434′, and 534′ is best seen in FIG. 7 showing the exterior surface 34h of the tubular cylinder 34 in developed form.

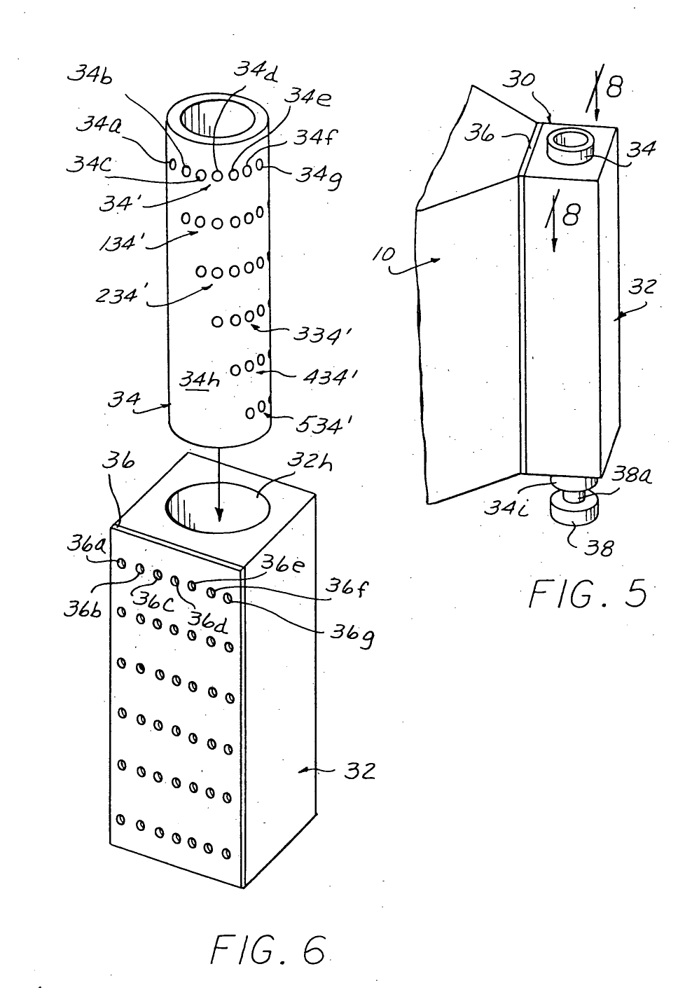

As shown in FIG. 5, control valve 30 further includes an electric motor 38 with an output shaft 38a drivingly connected to the lower end 34i of the tubular cylinder whereby selective actuation of motor 38 produces selective rotation of tubular cylinder 34. As tubular cylinder 34 rotates, selective sets of ports are brought into alignment with selective sets of passages in the valve body 32 to in turn to provide communication with selective sets of ports 36a-36g in the silicon seal 36 and in turn provide communication with selective sets of flow channels 12d-12j in a respective anode layer 12b of the fuel cell 10. Since the set of ports 34a-34g (34′), and sets 134′, 234′, 334′, 434′, and 534′ in the outer surface 34h of the tubular cylinder are selectively staggered in helix fashion, it will be seen that successive anode layers of the fuel cells 12, 14, 16, 18, 20 and 22 are successively vented as the tubular cylinder rotates with the venting occurring axially upwardly within the tubular cylinder 34 for exit at 50 and suitable discharge. Valve 30 thus provides a back pressure or flow method for gas management of the fuel cell stack 10 and specifically provides a mechanism for selectively and successively controlling pressure and flow of gasses in each individual cell rather than using an external valve to control the whole stack pressure and flow.

Valve 30 greatly reduces the power requirements for the associated compressor in that total flow at a given pressure is reduced since only a fraction of cells are being “gassed” at any point in time. That is, when certain cells are closed and consuming the oxygen and/or hydrogen, others are being vented resulting in a significant amount of gained efficiency. It will be seen that at any given point in time, certain anode layers in the fuel cell stack are being totally vented, other layers are being partially vented, and other layers are being totally blocked. The pressure remains constant and gases are consumed in the blocked layers and, in layers that are vented, gas flows freely out of the system and new gas enters the layer. The cycle repeats with each complete revolution of the tubular cylinder. The exact pattern of the sets of ports in the outer periphery 34h of the tubular cylinder 34 can of course be selectively varied to selectively vary the manner and timing of the blocking and venting of the individual layers in the fuel cell. The helix configuration seen in FIG. 7 provides successive venting of successively lower anode layers in the fuel cell but other venting and blocking combinations will be readily apparent.

Reference is now made to FIG. 4 wherein:

P=inlet pressure

F=total flow

f=individual cell flow

Δ=pressure drop inside each individual cell

p′ =P−sum of Δp

A certain inlet pressure P is required to obtain a certain amount of individual cell flow f in each of the cells of the stack. All cells are flowing at the required rate with a corresponding pressure drop Δ. Pressure drop Δ is a constant at any given individual cell flow f since it is determined by cell hardware. In order to maintain a certain individual cell flow f in each of the cells in the stack, it is necessary to control the inlet pressure P and the total flow F at the inlet. With the invention valve 30 positioned at the anode output, only a portion of the cells are open (for example, three of them at a time). The remaining cells are being provided back pressure from the valve with resultant savings. These closed cells continue to feel pressure P and gas is consumed more thoroughly. The reduced amount of overall flow (for example, only three cells at one time) requires less pressure to maintain the flow. As the tubular cylinder 34 of the valve 30 turns, the process is repeated for each cell or group of cells. One advantage of this arrangement is that there is a more uniform total voltage output when applying back pressure to individual cells rather than the whole stack 10 at once. The tubular cylinder 34 of the valve 30 may be turned at the most optimum rate depending on the power level desired. The rate of rotation could for example be 1 rpm or 60 rpm depending on system requirements. Another advantage is that a separate stack back pressure valve is no longer needed since the invention valve 24, 26, 28, 30 replaces this function. Also, since a smaller inlet pressure P is required (and total flow F for that matter), less energy is expended to provide the lower levels. It will also be possible to use a smaller fuel processor or a smaller hydrogen tank with a significant cost in energy savings.

Although the system has been described in detail thus far with respect to a system employing an invention valve 30 only at the anode output, invention valves can also be provided, as shown in FIG. 1, at the anode input (i.e., valve 24), the cathode input (i.e., valve 28), and the cathode output (i.e., valve 26). When the invention valves are used at the cathode input and output, it is possible to use a smaller air compressor or even a simple rootes blower. Utilization of the invention valve at both the input and output for either or both anode and cathode further enables fine tuning of the gas flow and/or pressure. Each of the valves of course may have a different tubular cylinder design but the concept remains the same. The individual valves may also require rotation at different speeds.

Although the valve bodies (for example, valve body 32 of valve 30) are shown as separate free standing structures at each corner of the fuel cell, in actual use it may be necessary to insert these valve bodies into existing fuel cell structure in which case the valve body might be split into two parts and then inserted by sliding the tubular cylinder down into the cylindrical bore defined by the body.

In the alternate embodiment of the invention seen in FIG. 9, the sets of arcuately spaced ports in the annular wall of the tubular cylinder (for example, ports 34a-34g) in FIG. 6 are replaced with arcuately extending slots. For example, as seen in FIG. 9, the annular wall 40h of the tubular cylinder 40 may include a series of angularly extending slots 40a, 40b, 40c, 40d, 40e, and 40f, which are angularly staggered in helix fashion so that the slots 40a-40f successively expose the flow channels in successively lower anode layers of the fuel cell stack 10, 14, 16, 18, 20, 22. The angular slots in each case have an angular extent approximating the angular extent of the combined ports 32a-32g so that as the tubular cylinder 40 rotates, each slot initially exposes one of the angled passage 32a and gradually exposes all of the passages 32a-32g before moving on to gradually close off the passages.

FIG. 9 also illustrates a further alternate feature of the invention wherein each slot 40a-40f has an accompanying auxiliary slot 40a-40f′ having a lesser angular extent than the respective parent slot 40a-40f so that, if the tubular cylinder 40 is indexed axially upward, as for example via a suitable power mechanism 42, the auxiliary slots 40a′-40f′ are moved into operative alignment with the respective anode layers of the fuel cell stack whereby to impart a totally different performance characteristic to the valve. Specifically, since the auxiliary arcuate slots 40a′-40f′ have a considerably less arcuate extent than the slots 40a-40f, the extent and nature of the venting of the cathode layer is less with subsequent variations in the behavior of the stack.

As a further alternate feature, the auxiliary slots 40a′-40f′ may be eliminated so that the upward indexing movement of the tubular cylinder has the effect of totally blocking all of the anode layers in the stack.

A further modification of the invention is seen in FIG. 10 wherein a developed surface 44h of a tubular cylinder 44 is provided with a series of rectangular openings 44a-44f which are arranged in staggered, helix fashion in the developed surface 44h for selective coaction with successive layers of the fuel cell as the tubular cylinder is rotated. The configuration of the openings 44a-44f may be such as to enable each opening or area to cover several layers of cells at the same time if desired.

In the modification seen FIG. 8a, the individual angled passages 32a-32g in the body 32 are replaced with a single fan-shaped slot 32j and the individual ports 34a-34g in the tubular cylinder 34 are replaced with an arcuate slot 34j having an angular extent corresponding to the angular extent of the inboard end of the fan-shaped slot 32i in the body.

As noted, the control valve of the invention may be utilized only at the anode output; may be used at each of the anode input and the anode output; may be used at each of the anode input, the anode output and the cathode output; or may be used at each of the anode input, the anode output, the cathode input and the cathode output. It will be understood that the flow through with respect to the anode layers is depleted hydrogen and the flow through with respect to the cathode layer is depleted air and water. In each case, the input may be fed axially downwardly into the tubular cylinder of the respective input valves 24, 28 and the discharge may be fed axially upwardly out of the tubular cylinder of the respective output valves 30, 26. As noted, the invention valve provides an improved apparatus and method for controlling back pressure and flow in a fuel cell stack and specifically reduces the power requirements for the system and simplifies the accessory hardware required to control the flow through the various layers of the fuel cell. The invention control valve also provides a more precise control of the timing and quantity of flow occurring in each level of the fuel cell stack.

Another advantage would be the increased active area on each cell due to the potential reduction in area of the delivery channel. The increased active area of the cell means more power density for each cell, hence the entire stack.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A valving system for use with a fuel cell stack having successive alternating layers of air and hydrogen passageways, the valving system comprising:
a tubular cylinder having a plurality of vertically spaced and angularly staggered aperture means;
means for mounting the tubular cylinder for rotation about its lengthwise axis; and
means for bringing the plurality of vertically spaced and angularly staggered aperture means into communication with the alternating successive layers of air and hydrogen passageways as the tubular cylinder is rotated.

2. The valving system of claim 1, comprising a body extending the full height of the fuel cell stack, said body having a central bore for receiving the tubular cylinder and mounting the tubular cylinder for rotation about its lengthwise axis, said body having a face with a plurality of apertures in communication with the plurality of vertically spaced and angularly staggered aperture means and at least some of the successive alternating layers of air and hydrogen passageways.

3. The valving system of claim 2, wherein said body and tubular cylinder are positioned at an anode output of the fuel cell stack.

4. The valving system of claim 2, wherein said plurality of apertures in the face of the body includes a set of apertures for each anode layer in the fuel cell stack.

5. The valving system of claim 4, wherein the sets of apertures in the body are angularly staggered with respect to each other.

6. The valving system of claim 4, wherein the sets of apertures are arranged in helix fashion with respect to each other.

7. The valving system of claim 2, further comprising an electric motor with an output shaft drivingly connected to a lower end of the tubular cylinder for selective rotation of the tubular cylinder.

8. The valving system of claim 1, further comprising means for successively venting successive anode layers of the fuel cells.

9. The valving system of claim 8, wherein the means for successively venting includes sets of ports in the outer surface of the tubular cylinder, wherein the ports are selectively staggered in helix fashion.

10. The valving system of claim 8, wherein the means of successively venting includes a series of angularly extending slots staggered in a helix fashion so that the slots successively expose flow channels in successive layers of the fuel cell stack.

11. The valving system of claim 10, wherein each angularly extending slots has an accompanying auxiliary slot having a lesser angular extent than the series of angularly extending slots.

12. The valving system of claim 8 wherein the means of successively venting includes a series of rectangular openings arranged in a staggered helix configuration in the tubular cylinders.

13. The valving system of claim 8, wherein the means of successively venting includes a single fan shaped slot in the body and individual ports in the tubular cylinder.

14. The valving system of claim 1, wherein the valve is also positioned at at least one of the anode input, the cathode input and the cathode output.
